(19) United States
(12) Patent Application Publication
(10) Pub. No.: US 2012/0145292 A1
(43) Pub. Date: Jun. 14, 2012

(54) VEHICLE COVER

(76) Inventors: John Jay Saggau, Soquel, CA (US); Andrew Jones, Santa Cruz, CA (US); Dave Molinari, Huntington Beach, CA (US)

(21) Appl. No.: 12/964,715

(22) Filed: Dec. 9, 2010

(51) Int. Cl. B62J 19/00

(52) U.S. Cl. 150/167

(57) ABSTRACT

A form-fitting protective vehicle cover is disclosed. Example embodiments include a fabric sheet for protecting a vehicle and vehicle components, wherein said fabric sheet is flexible and weather resistant, the fabric sheet being configured with a forward portion to cover handle bars of the vehicle, attachment strips configured to releaseably attach the forward portion of the fabric sheet to an aft portion of the fabric sheet to securely cover the handle bars of the vehicle, the attachment strips being releasable to enable the forward portion to be folded back to expose the handle bars; shroud pockets integrated into the underside of the fabric sheet to form a pocket to capture a component of the vehicle; and heat shields integrated into the underside of the fabric sheet to form to form an extra layer of protection for particular vehicle components.

### CROSS-REFERENCE TO RELATED PATENT APPLICATIONS

This patent application is related to U.S. patent application Ser. No. ______; filed on ______; and filed by the same applicant as the present patent application.

### BACKGROUND

### Copyright Notice

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the disclosure herein and to the drawings that form a part of this document: Copyright 2009-2010, John Saggau, Andrew Jones, & Dave Molinari; All Rights Reserved.

### TECHNICAL FIELD

This disclosure relates to protective vehicle covers, more specifically, to a lightweight protective covering for motorcycles and other two-wheeled vehicles.

### RELATED ART

The deteriorating effects of direct sunlight and water are well known and much time, effort, and money has been spent protecting vehicles and other items from these effects. The detrimental effects commonly include fading, blistering, and cracking. The largest impact from these effects is often felt by the uppermost horizontal surfaces of vehicles.

Vehicles such as motorcycles, bicycles, motor scooters, all terrain vehicles, personal watercraft, snowmobiles, and similarly designed vehicles are particularly susceptible to these effects since, by design, the vehicles are used in outdoor conditions and have no protective bodies or coverings inherently incorporated in their design. Due to their manner of use, such vehicles are typically exposed to atmospheric elements for extended periods of time.

More specifically, vehicle owners such as motorcyclists often desire to protect their vehicles from damage that can be caused by exposure to rain and, particularly, by exposure to the sun. Commercially available covers are customarily made of material such as vinyl or canvas which is essentially non-stretchable in character. Such covers are normally relatively large and cumbersome, typically making them non-portable for a motorcyclist and rendering the vehicle un-serviceable without removal of the cover.

Such covers are usually draped over the motorcycle and are relatively loose fitting, customarily being secured by ties or the like. In any event, such devices, being very loosely fit to the motorcycle, do not afford adequate protection from the elements. This situation is aggravated by virtue of the fact that motorcycles come in various sizes and configurations, while the conventional covers do not.

In addition, motorcycle riders utilize their motorcycles for many purposes, including pleasure trips, running errands, and riding to and from work. It is therefore desirable that the seat and fuel tank be kept free of dust, dirt, heat, and moisture which may accumulate when the motorcycle is parked, so as not to soil the rider's clothes and to keep the motorcycle clean and protected from the elements. In hot climates, the black vinyl or metal material of which motorcycle seats and fuel tanks are typically composed may become very hot, causing considerable discomfort to the rider when first mounting the motorcycle, un-safe temperature increases in the fuel tank, and a degradation of engine performance. Such heat further serves to seriously degrade the vinyl material or other components of the motorcycle. Many motorcycle riders also take pride in the overall appearance of their motorcycle, especially in the cleanliness and shininess of the fuel tank. The intense sunlight and high temperatures that characterize the motorcycle riding season, rapidly oxidizes the paint or lacquer finish of motorcycle fuel tanks, providing a degraded appearance and performance. Some examples of motorcycle coverings and protectors that have been the subject of patent filings include the following:

U.S. Pat. No. 4,283,084 describes a lightweight covering for a motorcycle that can be folded into a compact hand-size package when not in use. The covering extends from the back of a motorcycle seat to the front of the tank and covers both sides of the engine. Side loops are provided for securing the cover to corresponding motorcycle foot posts and opposing front corners are adapted to overlap in front of the engine and releasably attach to each other.

U.S. Pat. No. 5,795,009 describes a removable sun shade for motorcycles that includes a fabric sheet for generally taut extension over the upper part of the motorcycle, thereby forming an air-circulating region between the motorcycle and the sheet, the sheet including a plurality of attachment members disposed at spaced intervals around its periphery for placement about selected parts of the motorcycle to maintain the sheet in place over the motorcycle. A storage pouch is affixed to the sheet and is adapted for detachable connection to the motorcycle.

U.S. Patent Publication No. 2009/0025843 describes a removable protective vehicle cover for motorcycles and similarly designed vehicles for protecting the upper surface of the vehicle from the elements. A cover sheet component protects vehicle structures disposed rearward of the handlebars and incorporates two front mounting elements for releasably receiving forward structures of the vehicle. The cover sheet is deployed in a generally horizontal plane and provides minimal wind resistance to any such lateral forces. An optional cover module protects vehicle components disposed forward of the handlebars and may be releasably attached to the front edge of the cover sheet. A storage pouch may be integrally incorporated with the vehicle cover to allow for compact storage and portability of the vehicle cover when not in use.

Thus, a form-fitting protective vehicle cover is needed.

### BRIEF DESCRIPTION OF THE DRAWINGS

Embodiments illustrated by way of example and not limitation in the figures of the accompanying drawings, in which:

FIG. 1 is a left side view of the vehicle cover, in accordance with a preferred embodiment of the present invention, in use on a vehicle;

FIG. 2 is a right side view of the vehicle cover, as shown in FIG. 1, in use on the vehicle;

FIG. 3 is a left side view of the forward portion of the vehicle cover, as shown in FIG. 1, in use on the vehicle;

FIG. 4 is a right side view of the forward portion of the vehicle cover, as shown in FIG. 1, in use on the vehicle;

FIG. 5 is a top side and rear view of the vehicle cover, as shown in FIG. 1, in use on the vehicle and from a view point at the rear of the vehicle;

FIG. 6 is a front view of the vehicle cover, as shown in FIG. 1, in use on the vehicle;

FIG. 7 is a top side view of the forward portion of the vehicle cover, as shown in FIG. 1, in use on the vehicle;

FIG. 8 is a front view of the lower portion of the vehicle cover, as shown in FIG. 1, in use on the vehicle;

FIG. 9 is a left side view of the vehicle cover, as shown in FIG. 1;

FIG. 10 is a top side view of the vehicle cover, as shown in FIG. 1; and

FIG. 11 is a bottom side view of the vehicle cover, as shown in FIG. 1.

### DETAILED DESCRIPTION

A form-fitting protective vehicle cover is disclosed. In the following description, numerous specific details are set forth. However, it is understood that embodiments may be practiced without these specific details. In other instances, well-known processes, structures and techniques have not been shown in detail in order not to obscure the clarity of this description. Various embodiments are described below in connection with the figures provided herein.

### Overview of Various Embodiments

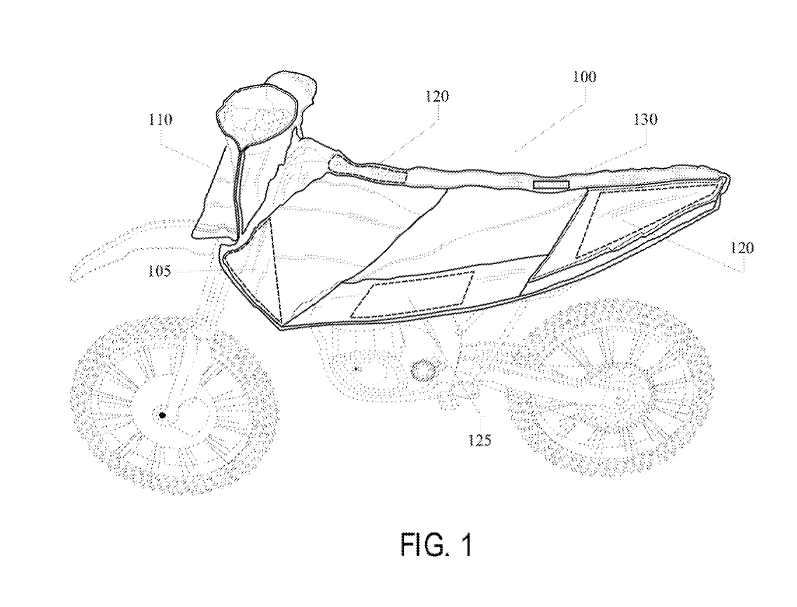

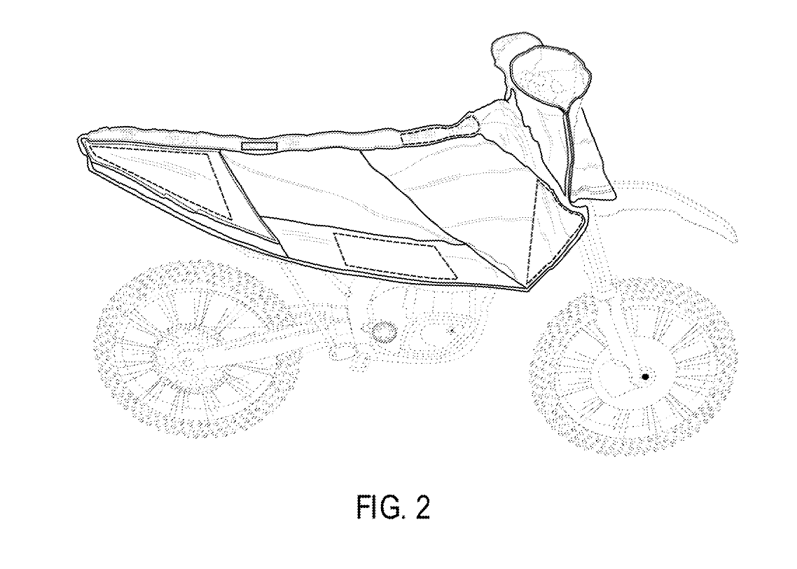

The form-fitting protective vehicle cover of the various embodiments described herein enables a user to protect a vehicle from the elements with a light-weight, easy to use, and multi-functional cover. In example embodiments, the vehicle cover can be used to fit the form of a motorcycle, bicycle, motor scooter, all terrain vehicle, personal watercraft, snowmobile, and the like. An example embodiment fit to a motorcycle is shown in FIGS. 1 and 2. FIG. 1 is a left side view of the vehicle cover 100, in accordance with a preferred embodiment of the present invention, in use on a vehicle. FIG. 2 is a right side view of the vehicle cover 100, as shown in FIG. 1, in use on the vehicle. As shown, the vehicle cover 100 overlays the rear fender, seat, gas tank, and front handle bars of a motorcycle. As described in more detail below, the vehicle cover 100 includes integrated shroud pockets and attachment loops to securely attach the vehicle cover 100 to the vehicle. Additionally, the vehicle cover 100 includes hook and loop (e.g., Velcro brand) attachment strips on a forward portion of the vehicle cover 100 to secure the vehicle cover 100 around the vehicle handle bars as shown in FIGS. 1 and 2. A particular embodiment also includes heat shields integrated into an underside of the vehicle cover to protect the gas tank and exhaust pipes of the vehicle.

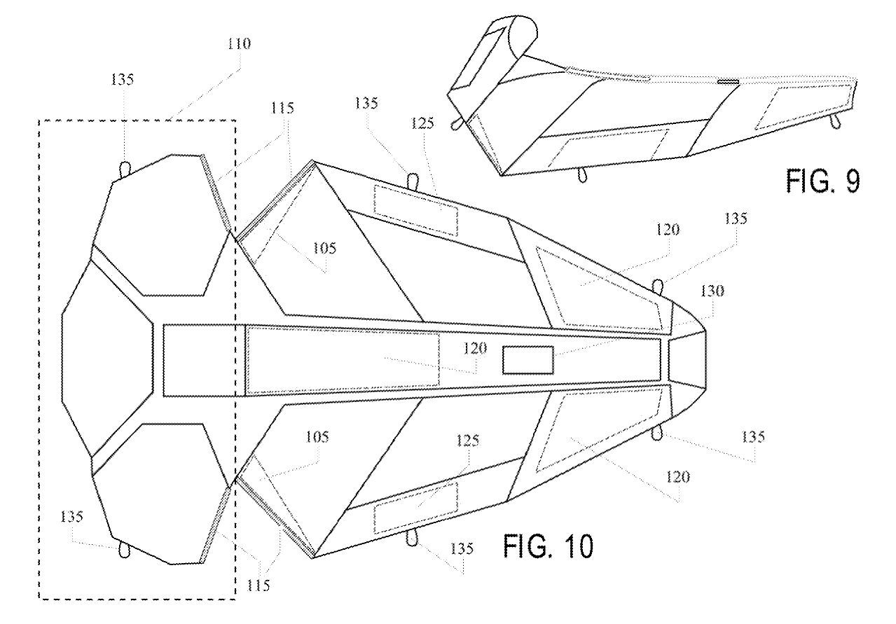

In an example embodiment, the vehicle cover 100 is fabricated from a light-weight, breathable fabric sheet that is resilient to cold weather, resilient to hot weather, and water resistant. In one embodiment, a 600 Denier polyester material can be used. Alternatively, a nylon material, vinyl material, Gore-Tex brand material, spandex, lycra, or canvas material can also be used. The 600 Denier polyester and nylon materials are non-stretchable; but, stretchable fabrics can also be used. The particular fabric sheet can be cut in diagonal strips or fabric portions as shown in FIGS. 9 through 11. The fabric portions can be sewn or bonded together at sturdy seams using techniques well known to those of ordinary skill in the art. The basic shapes of the fabric portions as sewn or bonded together to form the vehicle cover 100 of an example embodiment is shown in FIGS. 9 through 11. The vehicle cover 100 of an example embodiment includes a forward portion 110 that can be folded over the top of the handle bars of a vehicle and secured to the aft portion of the vehicle cover 100 with hook and loop (e.g., Velcro brand) attachment strips 115 (see FIGS. 9-11). The hook and loop (e.g., Velcro brand) attachment strips 115 serve to keep the vehicle cover 100 securely attached to the handle bars of a vehicle. The hook and loop (e.g., Velcro brand) attachment strips 115 can also be conveniently detached (i.e., separated or released) and the forward portion 110 of the vehicle cover 100 can be folded back over the fuel tank and seat of the motorcycle. This enables one to temporarily uncover the handle bars and use the handle bars to move the motorcycle without completely removing the vehicle cover 100 from the motorcycle. It will be apparent to those of ordinary skill in the art that an alternative attachment mechanism can also be used for the attachment strips in a particular embodiment. For example, snaps, zippers, buttons, or clips can also be used to releaseably attach the forward portion 110 of the vehicle cover 100 to the aft portion of the vehicle cover 100 to securely cover the handle bars of the vehicle and to firmly hold the vehicle cover in place over the vehicle.

In a particular embodiment, the vehicle cover 100 can also include shroud pockets 105 on a lower corner of the vehicle cover 100 as shown in FIGS. 1-11. In an example embodiment, the shroud pockets 105 comprise a small portion of fabric sewn or otherwise integrated into the underside of the vehicle cover 100 to form a pocket as shown in the Figures herein. The shroud pockets 105 are configured to enable a user to capture a component of the front forks, or other portion, of the motorcycle in the shroud pockets 105 as shown in FIG. 8. In this manner, the shroud pockets 105 can serve to both securely hold the vehicle cover 100 in place on the motorcycle and to protect components of the front forks, or other portion, of the motorcycle from direct exposure to the elements.

In a particular embodiment, the vehicle cover 100 can also include heat shields 120. The heat shields 120 can comprise heat resistant material or insulating material sewn or otherwise integrated into portions of the vehicle cover 100 as shown in FIGS. 1 through 5, 7, and 9 through 11. In a particular embodiment, the heat shields 120 can be sewn or otherwise integrated into the underside of the vehicle cover 100 to form an extra layer of protection for particular motorcycle components, such as the gas tank and exhaust pipes. The heat shields 120 can serve to both protect sensitive motorcycle components from overheating due to direct sunlight, over-cooling due to excessive cold and to protect the vehicle cover 100 from damage due to motorcycle components that may become excessively hot. It will be apparent to those of ordinary skill in the art that any of the various motorcycle components can be similarly protected by sewing a heat shield 120 into the underside of the vehicle cover 100 at an appropriate location.

In a particular embodiment, the vehicle cover 100 can also include a utility pocket 125 on a lower portion of the vehicle cover 100 as shown in FIGS. 1 through 5, 7, and 9 through 11. In various embodiments, the utility pocket 125 can be provided on one or both sides of the vehicle cover 100 as shown in the Figures herein. In an example embodiment, the utility pocket 125 comprises a small portion of fabric sewn or otherwise integrated into the underside of the vehicle cover 100 to form a pocket as shown in the Figures herein. The utility pocket 125 is configured to enable a user to store tools, cleaning materials, or the like conveniently in a pocket in the vehicle cover 100. In various embodiments, the utility pocket 125 can be open at a top edge or provided with a zipper or other closure mechanism to enable closure of the utility pocket 125.

In a particular embodiment, the vehicle cover 100 can also include a traction panel 130 sewn or otherwise integrated into an outer side of the vehicle cover 100 at a location corresponding to the top of a motorcycle seat area or other horizontal surface of the vehicle. The traction panel 130 can comprise a textured material serving as a resting surface for a helmet or tools. The textured surface provided by the traction panel 130 serves to keep helmets or tools from sliding off the vehicle cover 100.

In a particular embodiment, the vehicle cover 100 can also include attachment loops 135 on a lower portion of the vehicle cover 100 as shown in FIGS. 9 through 11. In various embodiments, the attachment loops 135 can be sewn, or otherwise integrated into the underside of the vehicle cover 100, using well known techniques. The attachment loops 135 can be used with attachment straps or bungees to securely attach the vehicle cover 100 to a vehicle.

The various panels or fabric portions of the vehicle cover 100 can be customized in a variety of ways with colors, graphics, advertising, logos, or other embellishments that can be applied to the fabric portions using well known techniques. In this manner, the vehicle cover 100 can be a protective cover and a stylish accessory for the vehicle.

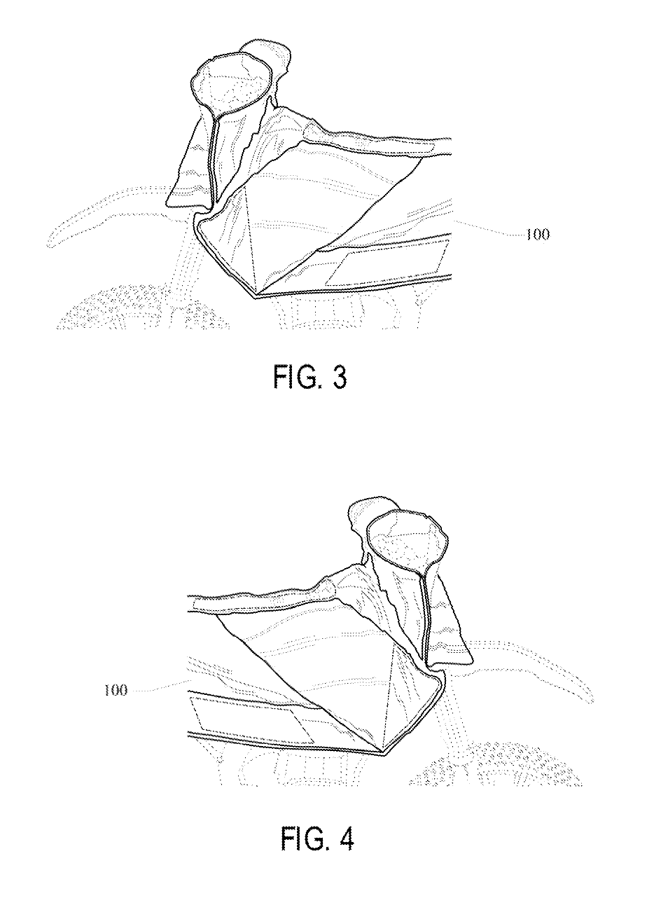

FIG. 3 is a left side view of the forward portion of the vehicle cover 100, as shown in FIG. 1, in use on the vehicle. FIG. 4 is a right side view of the forward portion of the vehicle cover 100, as shown in FIG. 1, in use on the vehicle.

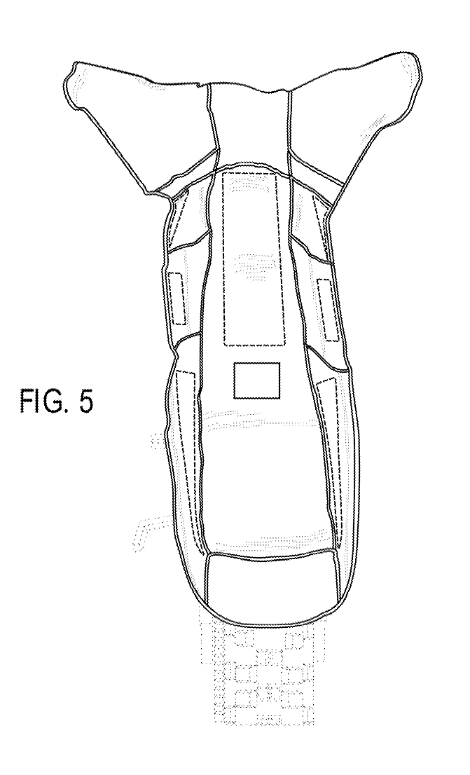

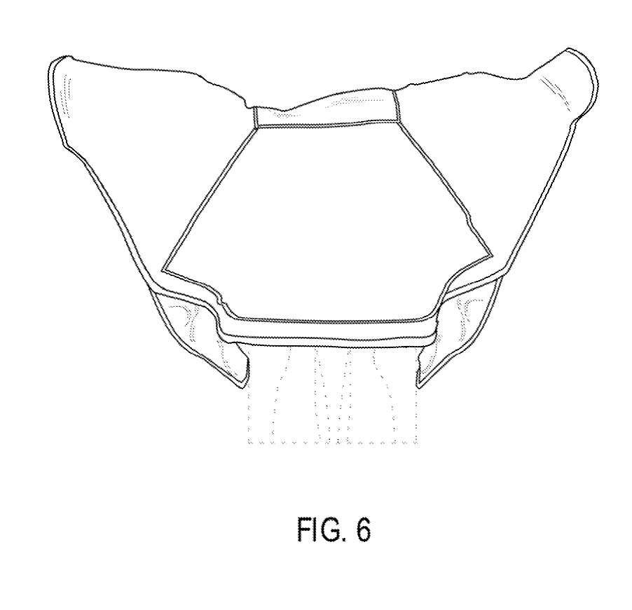

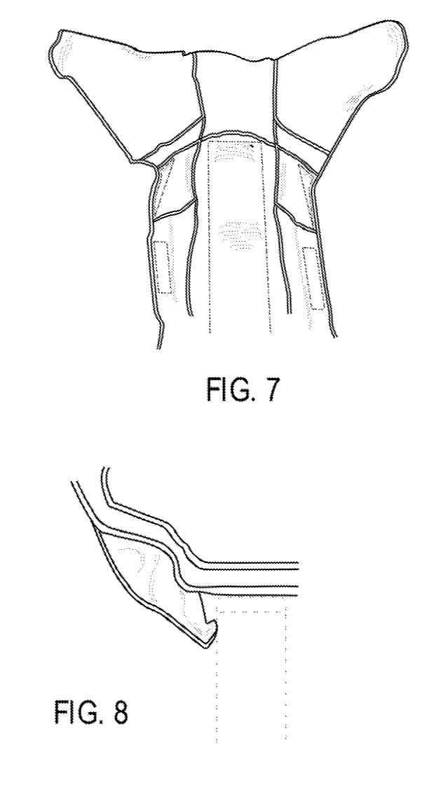

FIG. 5 is a top side and rear view of the vehicle cover 100, as shown in FIG. 1, in use on the vehicle and from a view point at the rear of the vehicle. FIG. 6 is a front view of the vehicle cover 100, as shown in FIG. 1, in use on the vehicle. FIG. 7 is a top side view of the forward portion of the vehicle cover 100, as shown in FIG. 1, in use on the vehicle. FIG. 8 is a front view of the lower portion of the vehicle cover 100, as shown in FIG. 1, in use on the vehicle.

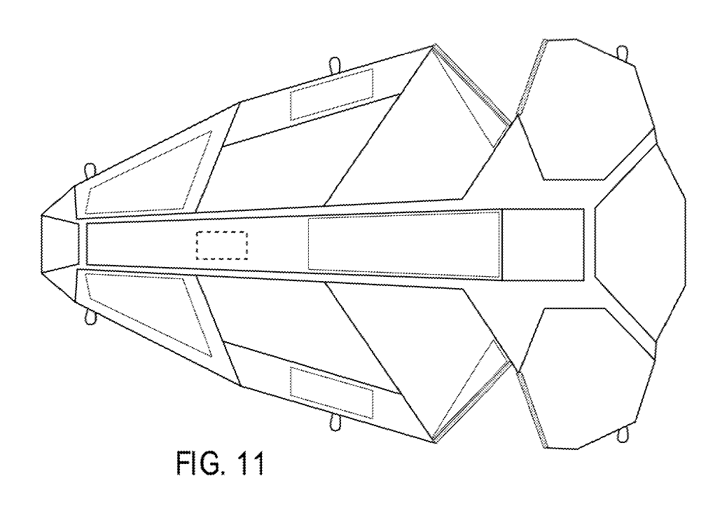

FIG. 9 is a left side view of the vehicle cover 100, as shown in FIG. 1. FIG. 10 is a top side view of the vehicle cover 100, as shown in FIG. 1. FIG. 11 is a bottom side view of the vehicle cover 100, as shown in FIG. 1.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”. “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

Thus, a form-fitting protective vehicle cover is disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A protective vehicle cover comprising:
a fabric sheet for protecting a vehicle and vehicle components, wherein said fabric sheet is flexible and weather resistant, the fabric sheet being configured with a forward portion to cover handle bars of the vehicle,
attachment strips configured to releaseably attach the forward portion of the fabric sheet to an aft portion of the fabric sheet to securely cover the handle bars of the vehicle, the attachment strips being releasable to enable the forward portion to be folded back to expose the handle bars;
shroud pockets integrated into the underside of the fabric sheet to form a pocket to capture a component of the vehicle; and
heat shields integrated into the underside of the fabric sheet to form to form an extra layer of protection for particular vehicle components.

2. The protective vehicle cover as claimed in claim 1 including a utility pocket integrated into the underside of the fabric sheet to form to a pocket for convenient storage of items.

3. The protective vehicle cover as claimed in claim 1 including a traction panel integrated into an outer side of the fabric sheet at a horizontal surface of the vehicle.

4. The protective vehicle cover as claimed in claim 1 including attachment loops on a lower portion of the fabric sheet.

5. The protective vehicle cover as claimed in claim 1 wherein the fabric sheet is comprised of a plurality of fabric portions sewn or bonded together.

6. The protective vehicle cover as claimed in claim 1 wherein the fabric sheet is fabricated from one of the materials from the group: 600 Denier polyester material, nylon material, vinyl material. Gore-Tex brand material, spandex, lycra, or canvas material.

7. The protective vehicle cover as claimed in claim 1 wherein the fabric sheet is comprised of a plurality of fabric portions sewn or bonded together and each fabric portion is customized with a variety of embellishments applied to each fabric portion.

8. The protective vehicle cover as claimed in claim 1 wherein the attachment strips are hook and loop attachment strips.

9. The protective vehicle cover as claimed in claim 1 wherein the heat shields are configured to protect a gas tank and exhaust pipes of the vehicle.

10. An apparatus comprising:
a sheet means for protecting a vehicle and vehicle components, wherein said sheet means is flexible and weather resistant, the sheet means being configured with a forward portion to cover handle bars of the vehicle,
attachment means configured to releaseably attach the forward portion of the sheet means to an aft portion of the sheet means to securely cover the handle bars of the vehicle, the attachment means being releasable to enable the forward portion to be folded back to expose the handle bars;
shroud pocket means integrated into the underside of the sheet means to form a pocket to capture a component of the vehicle; and
heat shield means integrated into the underside of the sheet means to form to form an extra layer of protection for particular vehicle components.

11. The apparatus as claimed in claim 10 including a utility pocket means integrated into the underside of the sheet means to form to a pocket for convenient storage of items.

12. The apparatus as claimed in claim 10 including a traction panel means integrated into an outer side of the sheet means at a horizontal surface of the vehicle.

13. The apparatus as claimed in claim 10 including attachment loop means on a lower portion of the sheet means.

14. The apparatus as claimed in claim 10 wherein the sheet means is comprised of a plurality of fabric portions sewn or bonded together.

15. The apparatus as claimed in claim 10 wherein the sheet means is fabricated from one of the materials from the group: 600 Denier polyester material, nylon material, vinyl material, Gore-Tex brand material, spandex, lycra, or canvas material.

16. The apparatus as claimed in claim 10 wherein the sheet means is comprised of a plurality of fabric portions sewn or bonded together and each fabric portion is customized with a variety of embellishments applied to each fabric portion.

17. The apparatus as claimed in claim 10 wherein the attachment means are hook and loop attachment strips.

18. The apparatus as claimed in claim 10 wherein the heat shield means are configured to protect a gas tank and exhaust pipes of the vehicle.
